(19) United States
(12) Patent Application Publication
(10) Pub. No.: US 2004/0215806 A1
(43) Pub. Date: Oct. 28, 2004

(54) On the fly offering and allocation of bandwidth on demand

(75) Inventors: Pablo Brenner, Montevideo (UY); Sergio Cabral Cavalcanti, Petropolis (BR); Luiz Cezar Fernandes, Petropolis (BR)

Correspondence Address: CURTIS MALLET-PREVOST COLT & MOSLE,LLP, 101 PARK AVENUE, 35TH FLOOR, NEW YORK, NY, 10178, US

(73) Assignee: Idea Valley do Brasil, Petropolis (BR)

(21) Appl. No.: 10/420,152

(22) Filed: Apr. 22, 2003

(51) Int. Cl. G06F 15/16

(52) U.S. Cl. 709/232; 709/218

(57) ABSTRACT

The invention allows for an Internet service provider to monitor its available bandwidth and offer users excess bandwidth at varying rates, hence filling the backbone when unused. The method is implemented by an apparatus who monitors traffic requests from the customer, and when recognizing a big data transfer will calculate the time needed to transfer the requested data, check if more bandwidth could be allocated, and offer a bandwidth increase for a predefined period of time in order to speed up this data transfer.

### BACKGROUND OF THE INVENTION

1. Technical Field

This invention relates to computer networks, and more particularly to sending and retrieving data over the Internet.

2. Description of the Related Art

Retrieving data from remote servers over the Internet is impeded by delays often encountered between the time data is requested and the time when it has been retrieved and made available for display on a user's computer station. Users spend a lot of time waiting for such data exchange. The download time can vary significantly depending on several factors, including the amount of data to be downloaded, the transmission bandwidth available between the user and its Internet service provider or “Access Provider,” and the transmission bandwidth to the Internet backbone that said Access Provider allocates to the client. These factors are often time and context-sensitive.

Network traffic usage is generally not well distributed. At one time, a user will select a link from a hypertext document on the screen, and for a time there is heavy communication on the network between the user and the server. The user then reads the new page while the communication path between client and server remains idle; the network bandwidth may indeed be not used for long period of time. If Access Providers allocated bandwidth in a fixed manner for each user, most of this bandwidth would be unused for a majority of the time.

Backbone connection to the Internet is one of the main costs for an Access Provider, mainly when located outside the USA, and as such it should be used wisely. The main problem is that traffic patterns consist of “peaks” and “valleys,” so that an Access Provider providing large bandwidth for all users to accommodate “peaks,” will often have deeper “valleys”, meaning lost revenue. Most broadband Access Providers use statistical analysis on bandwidth usage in order to optimize backbone cost through over subscription, meaning that they resell more bandwidth that what they really have, assuming that not all the users will use their allocated bandwidth at a given time. As bandwidth usage is not evenly distributed during any given time period, most of the time Access Providers are not using a significant portion of their available bandwidth.

Currently there are many ways for alleviating the problem, ranging from keeping copies of most accessed pages in local servers so there is no need to use the backbone or sending the file via email later. This techniques help on reducing backbone usage on peak hours, but none of them solves the problem of utilizing the backbone (and generating revenues for the Access Provider) when the backbone is sub-utilized.

It is therefore one object of the present invention to provide an improved method of sending and receiving data over a computer network.

It is another object of the present invention to provide an improved and more efficient method for retrieving files of data from remote locations via the Internet, particularly a method which allows the Access Provider to offer the user the possibility to increase its bandwidth for the time needed to finish such transaction.

The above objects are separate and distinct from one another; all such objects as well as additional objects, features, and advantages of the present invention will become apparent in the following detailed written description.

### SUMMARY OF THE INVENTION

According to one embodiment of the invention, a computer network such as the Internet has servers to deliver pages and/or files of data to remote users upon demand, and these pages usually contain links to further pages. Typically the connection between these two computers (the user and the server) goes through a mesh of other computers (the network) some of them belonging to the Access Provider (called here proxy-servers). The request for data is in the form of a page address sent by the user, identifying a specific page, usually by a uniform resource locator or “URL.” The proxy-server has the ability to generate context-sensitive information about delivery of this page, including current loading at the server, transmission bandwidth between the user and the proxy-server, transmission bandwidth between the proxy-server and the server, and size of the data requested. The proxy-server can calculate the time needed to transfer the requested data, and send this information to the user, offering the user the option to temporarily increase its available bandwidth in order to speed up the download. The user can then decide whether to increase its bandwidth for a given rate, based on the information sent by the proxy-server. The browser may have default or user-selected settings specifying whether to accept or reject an offer meeting certain criteria. For example, a user-selected setting may provide that if the download will take more than 3 minutes, and the proxy-server is offering to reduce the download time by more than 50% and at a cost less than one dollar, such an offer should be accepted. As another example, a user-selected setting may reject all offers at a cost greater than one dollar regardless of the reduction in download time. Thus, the user can specify when and how much the user is willing to pay for more bandwidth. If the browser has no default settings, then the proxy-server may send the context-sensitive information, and the user station may display the information for a download when action is requested. In this manner, receipt of information can be selective, based on user's needs and network delays.

### BRIEF DESCRIPTION OF THE DRAWINGS

The novel features believed characteristic of the invention are set forth in the appended claims. The invention itself, however, as well as a preferred mode of use, and further objects and advantages thereof, will best be understood by reference to the following detailed description of an illustrative embodiment, when read in conjunction with the accompanying drawings, wherein:

FIG. 1 is an electrical diagram in block form of a computer network which may use the features of the present invention;

FIG. 2 is a logic flow chart of the method employed at a user station, according to one embodiment of the invention; and

FIG. 3 is a logic flow chart of the method employed at the proxy-server, according to the embodiment of the invention of FIG. 2.

### DETAILED DESCRIPTION OF PREFERRED EMBODIMENT

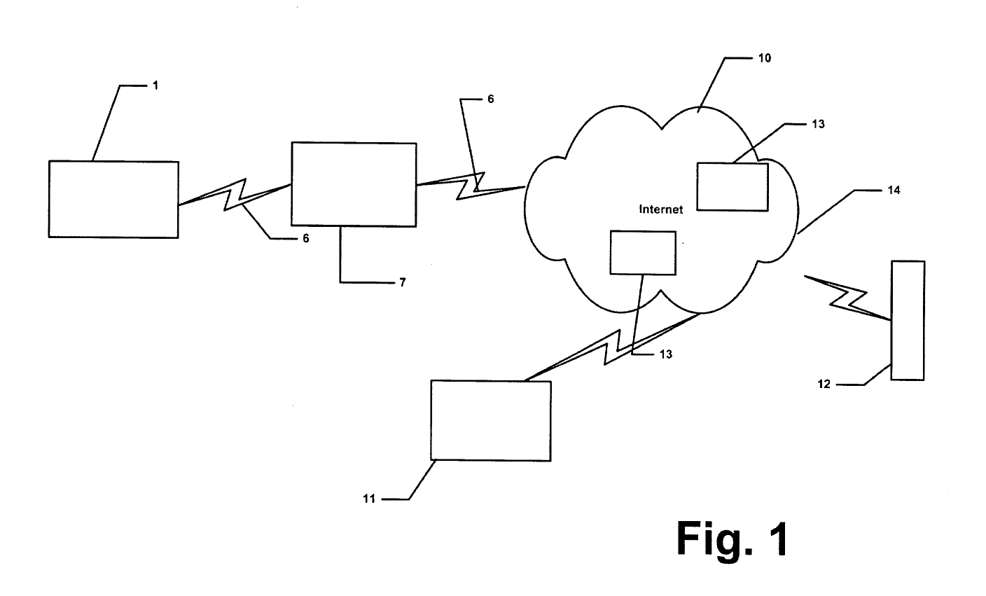

Referring to FIG. 1, a network system is shown which implements the concepts of the invention. A computer station 1 is employed by the user to obtain information from a network such as the Internet. The computer station 1 includes a monitor 2, a system unit 3, keyboard 4, mouse 5, in the usual manner. The system unit contains a CPU and system memory, and an adapter card or modem for connection to a network. For example, the station 1 may be connected by a wireless link 6 or modem to an Internet router or proxy-server 7 at the Access Provider premises. The system memory contains an operating system 8, e.g., AIX, UNIX, Windows, etc., and an applications program for accessing the network, such as an HTTP-compliant web browser 9 such as Internet Explorer. The proxy-server 7 or router is connected to a network 10, usually the Internet. Thus, the computer station 1 is able to send and receive messages to other stations on the network 10, and to retrieve information from the network or Internet 10, using standard network and application software.

The network 10 allows the user at station 1 to link with other servers and networks such as stations 11 and 12 to retrieve vast amounts of information. The term “Internet” refers to the collection of networks and gateways 13 and 14 that utilize the TCP/IP suite of protocols. TCP/IP is an acronym for “Transport Control Protocol/Interface Program,” a software protocol for communication between computers. Network 10, in the form of the Internet, is a system of geographically distributed computers 13 interconnected through the computers executing networking protocols, allowing users to interact and share information over the networks. The Internet has evolved as an “open” system for which developers can design software applications for performing specialized operations or services.

The usual way of navigating the Internet requires the user to click on each link when he was ready to view a given file, and the browser software in the user's computer station 1 would send out an associated URL for this link, and wait while the request is sent to the remote server, the file is retrieved and sent out by the server, and data makes its way back to the user station via the network 10. If the requested file is large, this process could last several minutes.

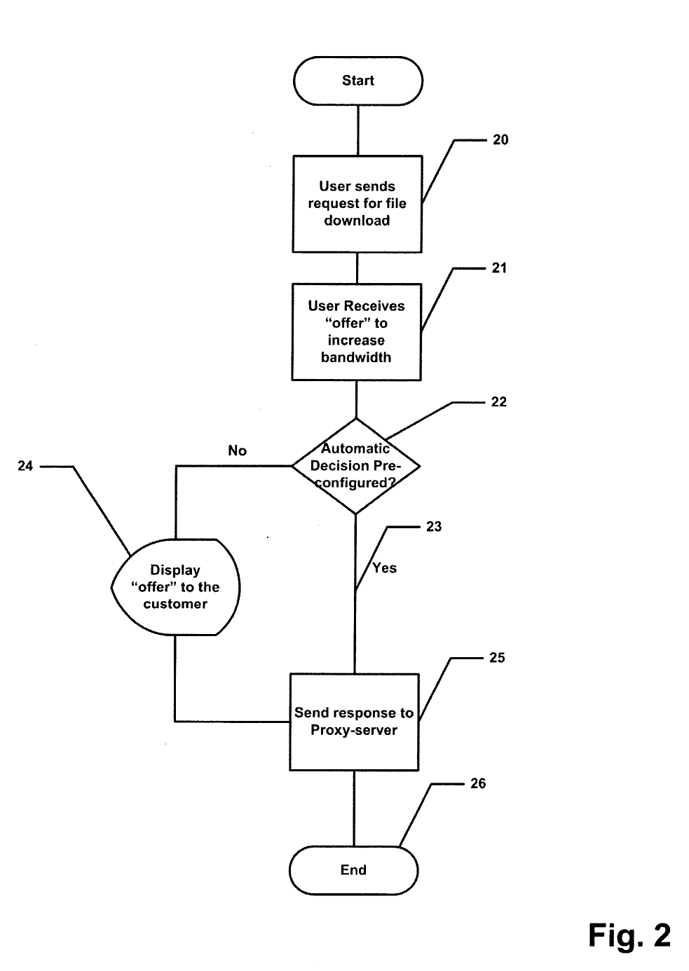

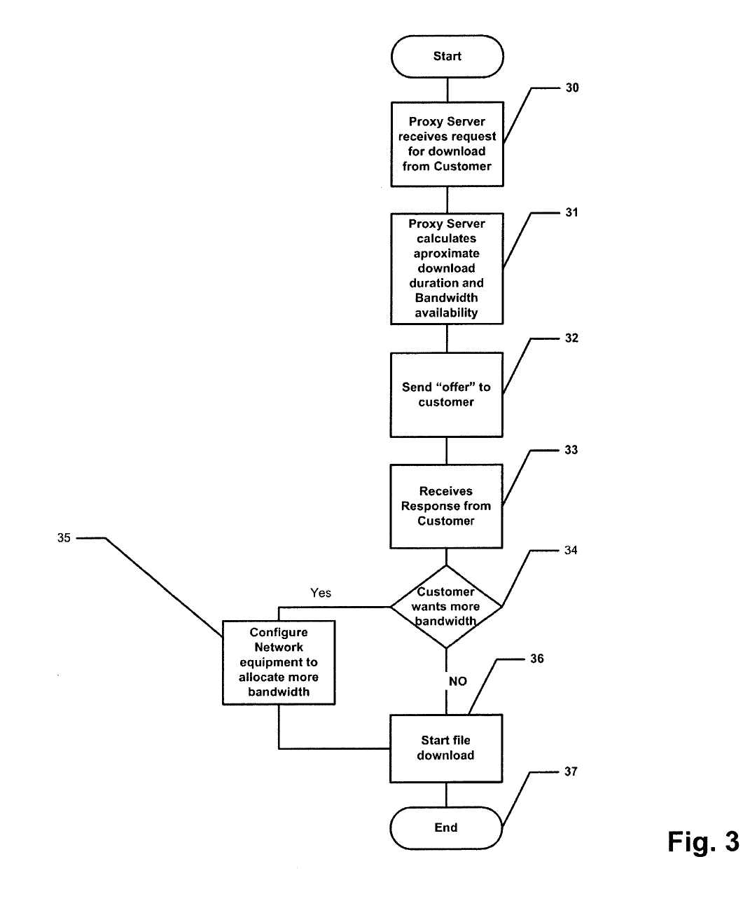

According to the invention, methods are provided to reduce the delay in downloading files of data via the Internet. The proxy-server 7, through whom all requests for pages or files go through, can monitor or estimate how long a particular file transfers would take, so in addition to its typical networking functions proxy-server 7 includes additional functions as explained in reference to FIGS. 2 and 3. These additional functions include gathering of information at the server about the quality of transfer at the present time from this proxy-server 7 to the user station 1, and from this proxy-server 7 to a remote file server 11, including an estimate of download time. The remote server 11 is often a computer executing a file server software application 15 over an operating system 16. The file server software 15 allows the server 11 to respond to a request for a given file, usually identified by a URL, by sending the file over the net to the user station 1. The file may include data, images, video, as well as Java applets, etc. The proxy-server 7, in addition to sending the request for the file download to the server 11, will send a message to user station 1, asking if the user wants to buy more bandwidth for this specific file transfer.

In one embodiment, illustrated in FIGS. 2 and 3, referenced herein by the numbered blocks, a user sends out a request for a specific file, e.g., by clicking on a link or URL, see block 20. The server 11 receives the request, block 30, and determines real-time context-sensitive information, e.g., determines the size of the file or other data that is being requested and the bandwidth available, and calculates the download time, block 31, and sends an offer to the client to increase its bandwidth, block 32. The user station 1 receives the information from the proxy-server 7, block 21, and refers to user preferences stored at the user station to generate a response to the server, block 22. The user preferences may be preconfigured settings, decision path 23, for example, a setting which specifies: if file transfer would take longer than 3 minutes, accept to pay up to 1 dollar in order to reduce this time by half, or if those are not pre-configured it will show the user a screen for accepting or rejecting the offer, block 24. Thus, the user station can accept or discard the offer. Response is sent to the proxy-server by the user station, block 25, and received at the proxy server 7, block 33. The proxy-server responds to the user's instructions by configuring network elements to allocate more bandwidth, block 35, and/or executing the file, block 36. The user station receives the data (if sent) and displays it or stores it in a folder, according to its request, block 26.

While the invention has been shown and described with reference to a particular embodiment, it will be understood that various changes in form and detail of the preferred embodiment, as well as other embodiments of the invention, may be made by those skilled in the art without departing from the true spirit and scope of the invention.

What is claimed is:

1. A computer network having a first station and a second station and a third station, the stations being separated from one another and coupled by said network such that traffic from the first station to the third station passes through the second station, comprising:
a request mechanism at said first station for requesting data from said third station;
a reply mechanism at said second station for sending to said first station in response to a said data request an indication of time-delay conditions for transfer of data from said third station, and an indication of possible transfer methods for said transfer of data;
a selection mechanism in said first station for sending instructions to said second station based on said indication, said instructions identifying a transfer speed for said data.

2. A computer network according to claim 1 wherein said first station is a user station, said second station is one of a router or proxy server, said third station is a remote server.

3. A computer network according to claim 1 wherein said network is the Internet and uses at least one of TCP/IP, FTP and hypertext transmission protocols, and said data comprises a data file identified by a universal resource locator address.

4. A computer network according to claim 3 wherein said indication is based on the size of said data and transmission bandwidth for said first station.

5. A computer network according to claim 4 wherein said transfer method comprises a plurality of options,

6. The computer network of claim 5, where said plurality of options comprises varying bandwidths.

7. The computer network of claim 5, where said plurality of options comprises varying download speeds.

8. A computer network according to claim 3 wherein said indication is sent to said first station by said second station for transfer information for all or part of the data file.

9. A method of operating a computer network of the type having a first station, a second station and a third station, the first and third stations being separated from one another and coupled by said second station and said network, comprising the steps of:
sending a request for data from said first station to said third station;
sending from said second station to said first station in response to a said request an indication of time-delay conditions for transfer of data from said third station; and
sending instructions from said first station to said second station based on said indication, said instructions identifying a transfer method for said data.

10. A method according to claim 9 wherein said first station functions as a user station, said second station functions as a router or proxy server, said third station functions as a remote server, and said network uses Internet protocol.

11. A method according to claim 9 wherein said network is the Internet and uses TCP/IP and FTP transmission protocols, and said data comprises a file identified by a universal resource locator address.

12. A method according to claim 11 wherein said indication is generated based on size of said data and transmission bandwidth available for said first station.

13. A method according to claim 12 where said transfer method comprises a plurality of alternatives, said alternatives comprising at least one of varying bandwidth options and varying download speeds.

14. A method according to claim 111 wherein said indication is sent to said first station by said second station for all or part of the data file.

15. A method according to claim 14 wherein said first station sends instructions to said second station for each of said links in a programming language.

16. A computer program for providing delivery of data from a server on a network, wherein said data is displayed by a graphic interface at a user station, said computer program comprising:
transfer means for sending from said user station to said server a request for said data;
receiving means to receive from said server in response to a said request an indication of time-delay conditions for transfer of data from said server; and
said transfer means including means for sending instructions from said user station to said server based on said indication, said instructions identifying a transfer speed for said data.

17. A computer program according to claim 16 wherein said network is the Internet and uses at least one of TCP/IP, FTP and hypertext transmission protocols, and said data comprises a file identified by a universal resource locator address.

18. A computer program according to claim 17 wherein said indication is generated based on size of said data and transmission bandwidth available for said user station.

19. A computer program according to claim 18 wherein said transfer method comprises a plurality of alternatives, said alternatives comprising at least one of varying bandwidth options and varying download speeds.
